(19) United States
(12) Patent Application Publication
(10) Pub. No.: US 2021/0182366 A1
(43) Pub. Date: Jun. 17, 2021

(54) Multi-Faceted License Management Approach to Support Multi-Layered Product Structure

(71) Applicant: AT&T Intellectual Property I, L.P., Atlanta, GA (US)

(72) Inventors: James Fan, San Ramon, CA (US); Steven Polston, Flemington, NJ (US); Michelle Martens, Freehold, NJ (US); Sanjay Agraharam, Marlboro, NJ (US)

(73) Assignee: AT&T Intellectual Property I, L.P., Atlanta, GA (US)

(21) Appl. No.: 16/714,525

(22) Filed: Dec. 13, 2019

(51) Int. Cl. G06F 21/10; G06F 16/245

(52) U.S. Cl. CPC G06F 21/105; G06Q 2220/18; G06F 2221/0766; G06F 16/245

(57) ABSTRACT

Concepts and technologies disclosed herein are directed to a multi-faceted license management approach to support multi-layered product structure. A model creation design and onboarding (“MCDO”) module can create an asset based upon input received from an asset creator. The MCDO module can store the asset in an asset catalog. The MCDO module can receive a search request from a collaborator. In response to the search request, the MCDO module can parse the search request to identify search criteria to be used to search the asset catalog. The MCDO module can search the asset catalog based upon the search criteria. The MCDO module can receive search results that include the asset. The MCDO module can create an enhanced asset based upon the asset created by the asset creator combined with a contribution based upon input received from the collaborator. The MCDO can store the enhanced asset in the asset catalog.

### BACKGROUND

Software vendors utilize software license plan(s) to sell their software licenses to individuals, enterprises, organizations, and other entities. In order to carefully manage a number of acquired licenses, entities either develop their own custom license management tool software or acquire such a tool to keep track of internal license uses and to provide audit reports to software vendors in accordance with their license agreement(s). Recently, open source environments allow many entities to monetize their digital assets in various ways. Traditional license management software cannot keep up with innovative offerings or repackaging of a digital asset. In such a dynamic digital environment, entities need to be empowered to be able to test new product concepts without investing substantial financial and other resources.

### SUMMARY

Concepts and technologies disclosed herein are directed to a multi-faceted license management approach to support a multi-layered product structure. According to one aspect disclosed herein, a model creation design and onboarding (“MCDO”) module can create an asset based upon input received from an asset creator. The MCDO module can store the asset in an asset catalog, referred to herein as an enhanced multi-layered digital asset catalog (“EMDAC”) module. The MCDO module can receive a search request from a collaborator. In response to the search request, the MCDO module can parse the search request to identify search criteria to be used to search the asset catalog. The MCDO module can search the asset catalog based upon the search criteria. The MCDO module can receive search results that include the asset. The MCDO module can create an enhanced asset based upon the asset created by the asset creator combined with a contribution based upon input received from the collaborator. The MCDO can store the enhanced asset in the asset catalog.

In some embodiments, the MCDO module can create a revision of the asset based upon further input received from the asset creator. The MCDO module can store the revision of the asset in the EMDAC module. In some embodiments, the asset can be associated with a first license option. The enhanced asset can be associated with a second license. Each revision can be associated with a different license option.

In some embodiments, the MCDO module can receive a further search request from a further collaborator. In response to the further search request, the MCDO module can parse the further search request to identify further search criteria to be used to search the EMDAC module. The MCDO module can search the EMDAC module based upon the further search criteria. The MCDO module can receive further search results from the EMDAC module. The further search results can include the enhanced asset.

In some embodiments, the search results also can include a suggested version of the asset. The EMDAC module can store a plurality of versions of the asset. A first version of the asset can be associated with a first license option. A second version of the asset can be associated with a second license option.

In some embodiments, a special graph relationship (“SGRM”) module can track and log a collaboration between the asset creator and the collaborator. The SGRM module can analyze a contribution level of the asset creator and the collaborator. The SGRM module can create a relationship link to at least one license option agreed to by the asset creator and the collaborator.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an enablement platform that enables one or more asset creators and one or more collaborators to interact in support of the creation of one or more licensed digital assets, according to an illustrative embodiment of the concepts and technologies disclosed herein.

FIG. 2 is a diagram illustrating aspects of a relationship graph, according to an illustrative embodiment of the concepts and technologies disclosed herein.

FIG. 3 is a diagram illustrating aspects of an adaptive chain mechanism graph, according to an illustrative embodiment of the concepts and technologies disclosed herein.

FIG. 4 is a block diagram illustrating aspects of an operating environment in which embodiments of the concepts and technologies disclosed herein can be implemented, according to an illustrative embodiment.

FIG. 5 is a flow diagram illustrating aspects of a method for establishing an asset and initiating collaboration among collaborative entities, according to an illustrative embodiment of the concepts and technologies disclosed herein.

FIG. 6 is a flow diagram illustrating aspects of a method for collaboration tracking, according to an illustrative embodiment of the concepts and technologies disclosed herein.

FIG. 7 is a flow diagram illustrating aspects of a method for calculating contributions of collaborative entities to ensure fair compensation among the entities, according to an illustrative embodiment of the concepts and technologies disclosed herein.

FIG. 8 is a block diagram illustrating an example computer system, according to some illustrative embodiments.

FIG. 9 is a diagram illustrating a machine learning, according to an illustrative embodiment.

FIG. 10 schematically illustrates a network, according to an illustrative embodiment.

FIG. 11 is a block diagram illustrating a cloud computing environment capable of implementing aspects of the concepts and technologies disclosed herein.

### DETAILED DESCRIPTION

Today's license management mechanisms cannot maintain pace with innovative offerings and repackaging of a digital asset. A digital asset can be any digital construct that can be licensed. Common digital assets include computer applications, computer operating systems, application programming interfaces (“APIs”), video games, other interactive media, music, movies, raw datasets (e.g., marketing datasets, operations datasets, etc.) and the like.

In today's dynamic digital environment, digital asset creators need the capability to test new asset ideas without investing significant time, money, and other resources. There is a need for a platform to enable collaboration activities to allow any entity to capture valuable collaboration relationships data that can be used to support many innovative use cases. Marketing and licensing use cases are just two examples.

Even more important, in a digital world, a digital asset can be associated with a single line of computer code (e.g., of a computer application, operating system, API, or the like), a single verse of music, or even a single simplistic machine learning model. Each of these newly-defined digital “products” can be created by an individual, a company, or any other entity. This mini product structure offers collaboration opportunities through which other entities can enhance the digital asset and/or re-incorporate the digital asset into a new product, which, in turn, can offer new collaborative opportunities to others. There is a strong need for a tool to capture all of these complicated and dynamic collaboration relationships.

The concepts and technologies disclosed herein are directed to any digital asset type, such as any of the examples mentioned above. A digital asset becomes a product, or a “digital asset product,” when it is marketed, licensed, or otherwise made available to others. The concepts and technologies disclosed herein primarily are in the context of machine learning products. In this example, a digital asset product can be any of the following machine learning constructs, or some combination thereof. It should be understood that the machine learning constructs described below are merely examples, and should not be construed as being limiting in any way.

A digital asset product can be a pure machine learning algorithm. A digital asset product can be a machine learning algorithm that has been through a training process and the output is a machine learning model. A digital asset product can be a trained machine learning model that has been enriched with additional training datasets and is made available for further collaboration. It should be noted that a trained machine learning model can encompass a pure machine learning algorithm that has been licensed to a data scientist who trained the machine learning algorithm and turned it into a machine learning model that was later licensed to another data scientist who decided to add additional trainings to the trained model and then licensed the result to another individual or enterprise. A digital asset product can be a chain of machine learning models that together form a package that can be tailored to a license for a new use. The machine learning models in a chain can be developed or trained by different authors or data creators. A digital asset product may be a data-only license permutation. In this case, a first entity can license its unique dataset(s) to any data scientists who developed an algorithm but did not have their own training data.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

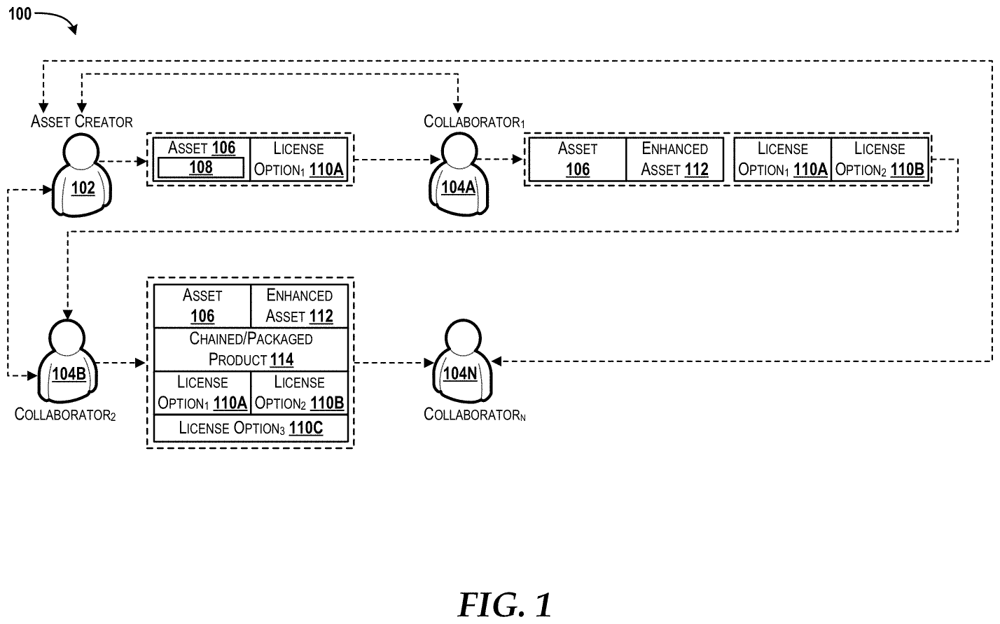

Turning now to FIG. 1, aspects of an enablement platform 100 that enables one or more asset creators 102 and one or more collaborators 104A-104N to interact in support of the creation of one or more licensed digital assets (“asset”) 106 will be described, according to an illustrated embodiment of the concepts and technologies disclosed herein. The asset 106 can be or can include a computer application, a computer operating system, an API, a video game, another form of interactive media, a song or other music, a movie or other video, combinations thereof, and the like. The asset 106 alternatively can be a single line of computer code (e.g., of a computer application, operating system, API, or the like), a single verse of music, or even a single simplistic machine learning model. The concepts and technologies disclosed herein are described in context of the asset 106 being a machine learning algorithm. This example is merely illustrative of one type of asset, and therefore should not be construed as being limiting in any way.

The asset creator 102 can be an individual, a group of individuals, an enterprise or other company, an organization, or any combination thereof. It is contemplated that multiple asset creators 102 may collaborate on creating the asset 106 as initially conceptualized prior to any of the collaborators 104 providing any input. Moreover, it should be understood that the “asset creator” and “collaborator” roles are used herein to help define the relationships among parties involved in the asset 106. In practice, an asset creator might also be a collaborator, and vice versa.

The asset 106 can be subject to any number of collaborations. Any particular number of collaborations illustrated or described herein is merely exemplary, and should not be construed as being limiting in any way. In the illustrated example, the enablement platform 100 includes one asset creator 102 that has created the asset 106. Again, the asset 106 will be described as a machine learning model, but this is just one non-limiting example. Those skilled in the art will appreciate the applicability of the concepts and technologies disclosed herein to other types of assets. The asset 106 can contain a set of sub-components 108. For example, the asset 106 may include one or more models and one or more data sets. The enablement platform 100 can support collaboration with the asset 106 as a whole or a portion thereof via the set of sub-components 108. Moreover, although the illustrated example shows a linear collaboration process. Collaborations can be conducted in parallel.

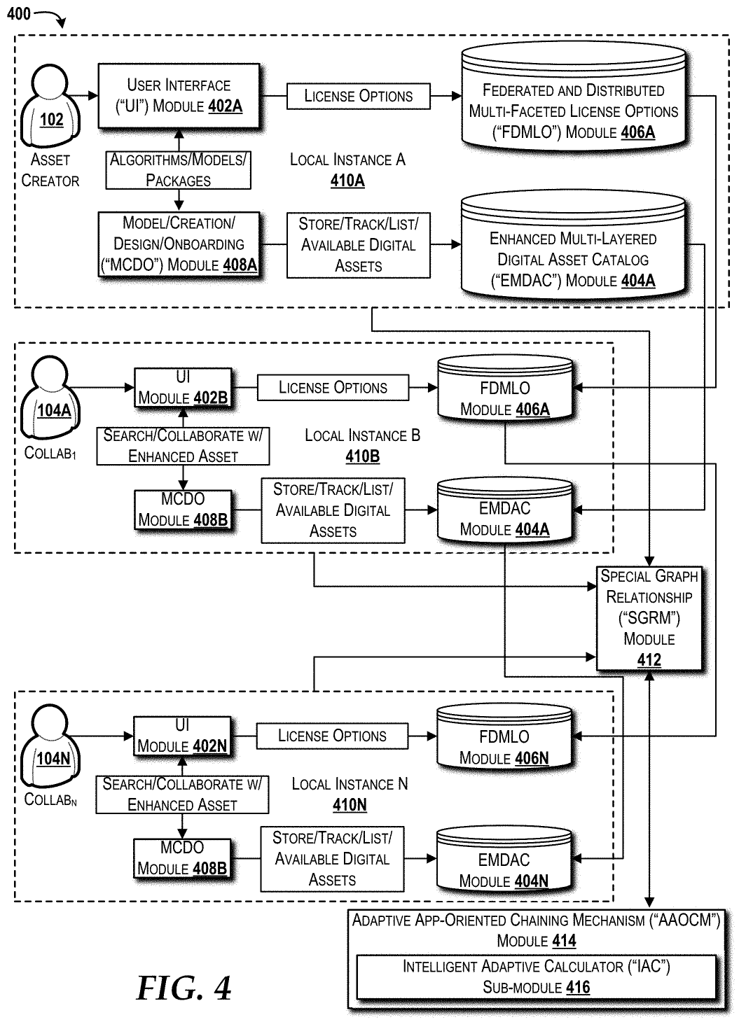

The type of the collaboration in each case can be determined by a collaboration type that is represented by metadata referred to herein as a license option 110. Examples of the license option 110 include, but are not limited to, direct, indirect, partial, whole, collaboration-only, and entitlement type. Custom license options 110 are also contemplated. In some cases, a uniquely defined custom license option 110 can itself be treated as a digital asset for collaboration. The collaboration activity can continue to evolve as shown in FIG. 1. Each collaboration may result in an enhanced asset 112 being republished back to a marketplace (best shown in FIG. 4) for further collaboration with a new license option selected as the metadata. In some instances, the original creator may decide to become a collaborator for the newly-enhanced digital asset.

In the illustrated example, the asset creator 102 may create the asset 106 with a first license option₁ 110A. After the asset 106 is created, a first collaborator (“collaborator₁”) 104A may use the asset 106 in accordance with the license option₁ 110A to enhance the asset 106, and thereby create an enhanced asset 112 for license in accordance with a second license option (“license option”) 110B. A second collaborator (“collaborator₂”) 104B can then use the asset 106 and the enhanced asset 112 in accordance with the license option₁ 110A and the license option 2110B to create a chained/packaged product 114 for license in accordance with a third license option (“license option₃”) 110C. Additional collaborators up to an n^{th} collaborator (“collaboratorₙ”) 104N can further enhance the enhanced asset 112, enhance the asset 106 in a different manner than the collaborator₁ enhanced the asset 106, and/or create one or more other chained/packaged products 114. The relationship links shown among the asset creator 102 and the collaborators 104A-104N have been simplified for readability. It should be understood that any relationship links can be formed among the asset creator 102 and the collaborators 104A-104N. As such, the example shown should not be construed as being limiting in any way.

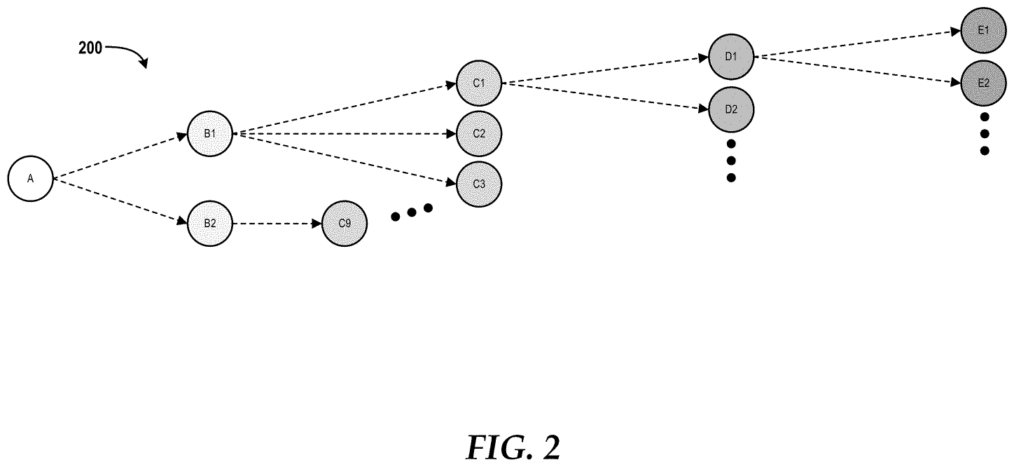

Turning now to FIG. 2, aspects of a relationship graph 200 will be described, according to an illustrated embodiment of the concepts and technologies disclosed herein. The relationship graph 200 represents the relationships to allow all participants in a collaboration to gain the trust necessary to allow an asset marketplace to thrive. Today, no viable solution exists to address this issue. The relationship graph 200 provides a novel mechanism by which to capture both implicit and explicit digital asset collaboration relationships.

The relationship graph 200 can be created by a special graph relationship (“SGRM”) module (SGRM module 412; best shown in FIG. 4) to capture the establishment of all kinds of relationships among the asset creator(s) 102 and the collaborators 104. An “internal relationship” is used here to define the relationship among sub-components of the asset 106, such as in the set of sub-components 108. The internal relationships within the asset 106 are carefully maintained/tracked because the collaborator(s) 104 may only choose partial sub-components to collaborate. Since either the asset 106 as a whole or a sub-component 108 of the asset 106 can be subject to a collaboration simultaneously by one of more of the collaborators 104, this type of “external relationship” is between an asset creator 102 and the collaborator(s) 104, and needs to be agreed upon via the license option(s) 110. The license option 110 is used as the metadata of the captured relationship. The collaboration activity can continue to evolve as described shown in the relationship graph 200 with no theoretical limit. Each collaboration may result in an enhanced asset 112 being republished back to the asset marketplace for further collaboration with a new license option 110 selected as the metadata of the newly-established relationship. In some instances, an asset creator 102 (i.e., the original creator of the asset 106) may decide to become a collaborator 104 for a newly-enhanced asset (e.g., the enhanced asset 112). This introduces a recursive relationship that is also supported by the SGRM module 412.

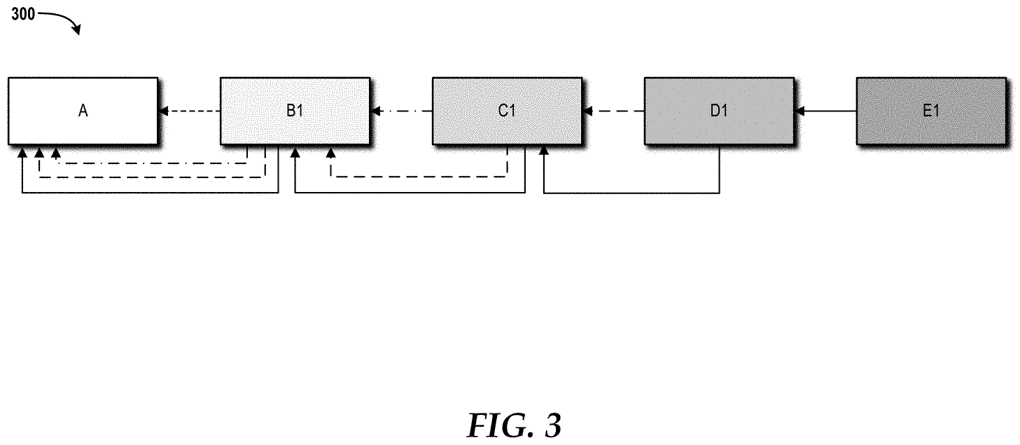

Turning now to FIG. 3, aspects of an adaptive chain mechanism graph 300 will be described, according to an illustrated embodiment of the concepts and technologies disclosed herein. An adaptive chain mechanism can be used to realize a given set of relationships for different usage purposes. There may be many uses of the relationship graph 200 described above with reference to FIG. 2. The adaptive chain mechanism graph 300 is used to illustrate a few example uses. It should be understood that these examples are merely exemplary, and should not be construed as being limiting in any way.

A first example use in which relationships are used for a unique personal marketing intelligence study tool will be described. In this example, an individual asset creator A has limited marketing resources. Assuming that A wants to understand the demand of his/her asset, A can create a beta version of the asset and publish the beta version of the asset to an asset marketplace. The beta version can be associated with metadata (i.e., a license option 110) for “no entitlement.” If the asset is in high demand, in a few days, there may be thousands of collaborators that would like to collaborate on the asset; in which case A can request the asset marketplace to generate an adaptive chain structure dedicated for A to study all the relationships for the published asset. From the chain structure, A can decide how to market the real asset (e.g., “shipping” version with complete feature capability), or A can decide to collaborate with one or more indirect collaborators on a case-by-case basis.

A second example use in which relationships are used for a license management tool to track entitlement of an asset creator and each collaborator will be described. The associated adaptive chain mechanism can generate any type of chain structure that is sourced based on the entitlement definition of each party sourced from the relationship graph (e.g., the relationship graph 200). The structure of the chain can vary based on each application. Each chain, although it was sourced from the same relationship graph, may look different. Moreover, it may not always be possible to use the chain to rebuild the relationship graph. The source of truth is always referred back to the relationship graph. The structure chain is just used as the execution vehicle per application/usage.

Turning now to FIG. 4, an operating environment 400 in which embodiments of the concepts and technologies disclosed herein can be implemented will be described, according to an illustrative embodiment. The illustrated operating environment 400 include a plurality of modules. The modules can be software modules executed, for example, by one or more computing systems, including traditional and/or virtualized computing systems. The modules can be hardware modules or combinations of hardware and software that perform the operations described herein.

A user interface (“UI”) module 402 can enable the asset creator 102 (e.g., the original creator) and the collaborator(s) 104 to browse an asset marketplace that is represented by an enhanced multi-layer digital asset catalog (“EMDAC”) module 404, and to view general license terms and conditions of one or more license options 110 from a federated and distributed multi-faceted license options (“FDMLO”) module 406.

A model creation/design/onboarding (“MCDO”) module 408 can enable a design environment for the asset creator 102 and the collaborator(s) 104 to design the asset 106 to be listed in the EMDAC module 404 for collaboration. For example, the MCDO module 408 can provide a design environment that the the asset creator 102 and/or the collaborators 104 can use to design algorithms, train models, and/or create packages for the EMDAC module 404.

The EMDAC module 404 can enable the asset creator 102 and the collaborator(s) 104 to onboard (i.e., list) the asset(s) 106 to form an asset marketplace through which users (e.g., the collaborators 104) can learn what assets 106 are available. The EMDAC module 404 is highly-federated, which means it provides a marketplace that is shared among a plurality of local instances 410A-410N. Each of the local instances 410 can include an instance of each of the modules described herein. For example, the local instance A 410A includes the UI module 402A, the EMDAC module 404A, the FDMLO module 406A, and the MCDO module 408A. Likewise, the other local instances 410B-410N include appropriately labeled instances of the modules.

The EMDAC module 404 introduces a novel feature that enables a concept referred to herein as a “cascading digital asset family” to be tracked seamlessly behind the scenes. The EMDAC module 404 may know, for example, that algorithm A is being used in package X and package Y. This information can be used by the FDMLO module 406 to build relationship graphs, such as the relationship graph 200, for licensing, marketing, and/or other uses.

The FDMLO module 406 can provide an open digital asset environment to utilize a self-served license mechanism. The FDMLO module 406 also enables the asset creator 102 and the collaborator(s) 104 to select which license option(s) 110 to use. A few examples of the license models that the FDMLO module 406 can support include, but are not limited to, (1) a right-to-use with one collaboration only, (2) a right-to-use with limited collaboration (e.g., two levels of collaboration or retraining collaboration), and (3) a right-to-use with full collaboration (e.g., maximize license opportunity with unlimited repackaging options).

The SGRM module 412 can enable a scalable way to keep track of a set of relationship graphs, such as the relationship graph 200. Each relationship graph can track the license relationships among the asset creator 102, one or more collaborators 104, and repackaged/relicensed enhancements (e.g., enhanced asset 112). With the capability of the SGRM module 412, no matter how many iterations of repackaging occur, the “ground truth” is well-maintained. The SGRM module 412 can be used by any entity on the relationship graph that has proper authorization.

As indicated above, the SGRM module 412 can be used to keep track of the asset creator 102 and the collaborator(s) 104 relationships for each and every asset 106. In a highly self-served/federated environment, “trust” is everything. Without the assurance of trust, the solution is not sustainable. This means, if the asset creator 102 fails to get what he/she intends to get (e.g., monetary compensation), the asset creator 102 might not return another time with a more innovative asset for a license opportunity.

An adaptive application-oriented chaining mechanism (“AAOCM”) module 414 can be used to empower each role in a relationship graph to demand a unique chain structure that clearly highlights an “execution view of the use of the relationship” per requestor. For example, the relationship graph 200 shown in FIG. 2 shows a creator A who publishes a model and later a collaboration occurs continuously with collaborators B, C, and D joining the relationship graph 200. The relationship graph 200 documents both direct and indirect relationships. Assuming the creator A offered a free machine learning model with the intention to expand their business reach by gaining as many relationships as possible, the creator A can request that the AAOCM module 414 show a chaining diagram, and can change all indirect relationships to direct relationships. In summary, the SGRM module 412 provides the ground truth. The AACOM 414 can use the ground truth to create a view to tailor a specific use of the relationship graph 200.

The AAOCM module 414 can include an intelligent adaptive calculator (“IAC”) sub-module 416. The IAC sub-module 416 can provide a capability to examine the relationship and chain graphs (e.g., the relationship graph 200 and the adaptive chain mechanism graph 300), and the associated with corresponding license options(s) 110 selected to determine a compensation value for each creator/collaborator. The IAC sub-module 416 can provide a tally function to perform aggregation for each entity based on preference(s). Because the IAC sub-module 416 is an intelligent calculator, the IAC sub-module 416 can be fed with one or more upgraded algorithm(s) that allow calculations to be as adaptive and flexible as possible. The IAC sub-module 416 ensures a level of trust that ties all parties together.

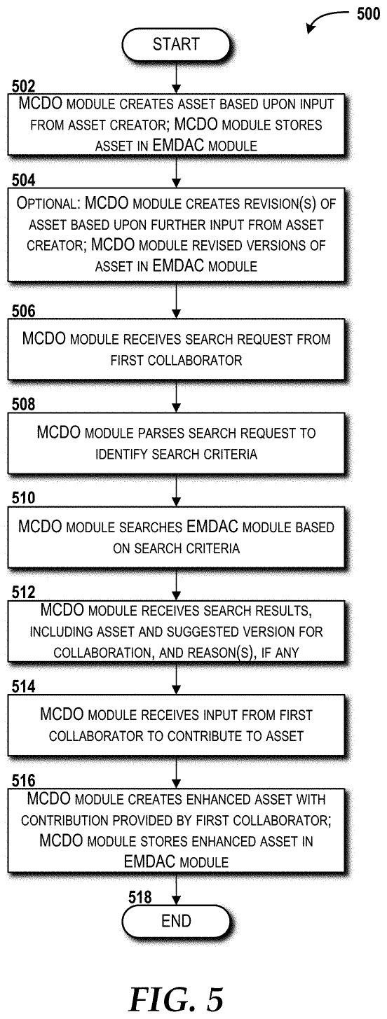

Turning now to FIG. 5, a flow diagram illustrating aspects of a method 500 for establishing an asset and initiating collaboration will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 500 will be described with reference to FIG. 5 and further reference to FIG. 4. The method 500 begins and proceeds to operation 502. At operation 502, the MCDO module 408 creates the asset 106 based upon input received from the asset creator 102 via the UI module 402, and stores the asset 106 in the EMDAC module 404, which provides an asset marketplace for the collaborators 104 to search.

From operation 502, the method 500 proceeds to operation 504. Operation 504 is shown as an optional operation. At operation 504, the MCDO module 408 creates one or more revisions of the asset 102 based upon further input received from the asset creator 102 via the UI module 402, and stores the revised versions of the asset 106 in the EMDAC module 404. The operation 504 is shown as a linear step in the method 500 between the operation 502 and the operation 506. It should be understood, however, that the operation 504 can be performed at any time. For example, the asset creator 102 may continually revise the asset 106 and update the EMDAC module 404 accordingly. The revisions can be alpha versions of the asset 106, beta versions of the asset 106, and so on, in addition to final versions of the asset 106 that may be revised from time to time.

From operation 504, the method 500 proceeds to operation 506. At operation 506, the MCDO module 408 receives a search request from the collaborator₁ 104A. From operation 506, the method 500 proceeds to operation 508. At operation 508, the MCDO module 408, in response to the search request, parses the search request to identify search criteria to be used to search the EMDAC module 404. From operation 508, the method 500 proceeds to operation 510. At operation 510, the MCDO module 408 searches the EMDAC module 404 based upon the search criteria identified at operation 508.

From operation 510, the method 500 proceeds to operation 512. At operation 512, the MCDO module 408 receives search results from the EMDAC module 404. The search results can include the asset 106, and may include a suggested version of the asset 106 for collaboration. The EMDAC module 404 additionally may include one or more reasons why the suggested version of the asset 106 was suggested.

From operation 512, the method 500 proceeds to operation 514. At operation 514, the MCDO module 408 receives input from the collaborator₁ 104A to contribute to the asset 106 (e.g., the suggested version of the asset 106). From operation 514, the method 500 proceeds to operation 516. At operation 516, the MCDO module 408 creates the enhanced asset 112 based upon the contribution provided by the collaborator₁ 104A, and stores the enhanced asset 112 in the EMDAC module 404. Other collaborators 104 can access the EMDAC module 404 to obtain the asset 106 and/or the enhanced asset 112 and make their own contributions thereto.

From operation 516, the method 500 proceeds to operation 518. The method 500 ends at operation 518.

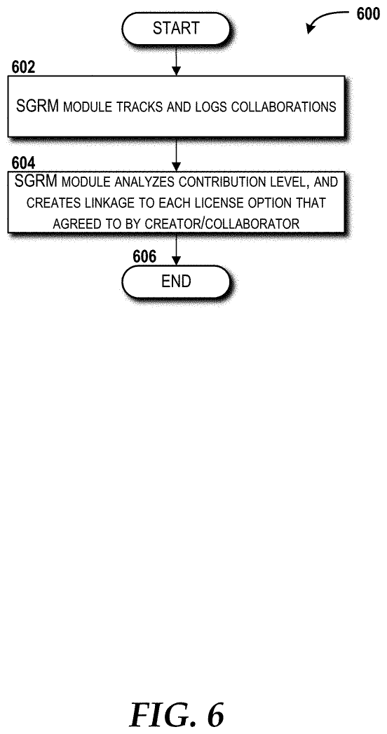

Turning now to FIG. 6, a flow diagram illustrating aspects of a method 600 for collaboration tracking will be described, according to an illustrative embodiment of the concepts and technologies disclosed herein. The method 600 will be described with reference to FIG. 6 and further reference to FIG. 4.

The method 600 begins and proceeds to operation 602. At operation 602, the SGRM module 412 tracks and logs collaborations. Whenever an asset 106 or its collaborated entity is touched, the relationship is tracked and logged by the SGRM module 412. Even if the collaboration ended nowhere, the SGRM module 412 can track what happened.

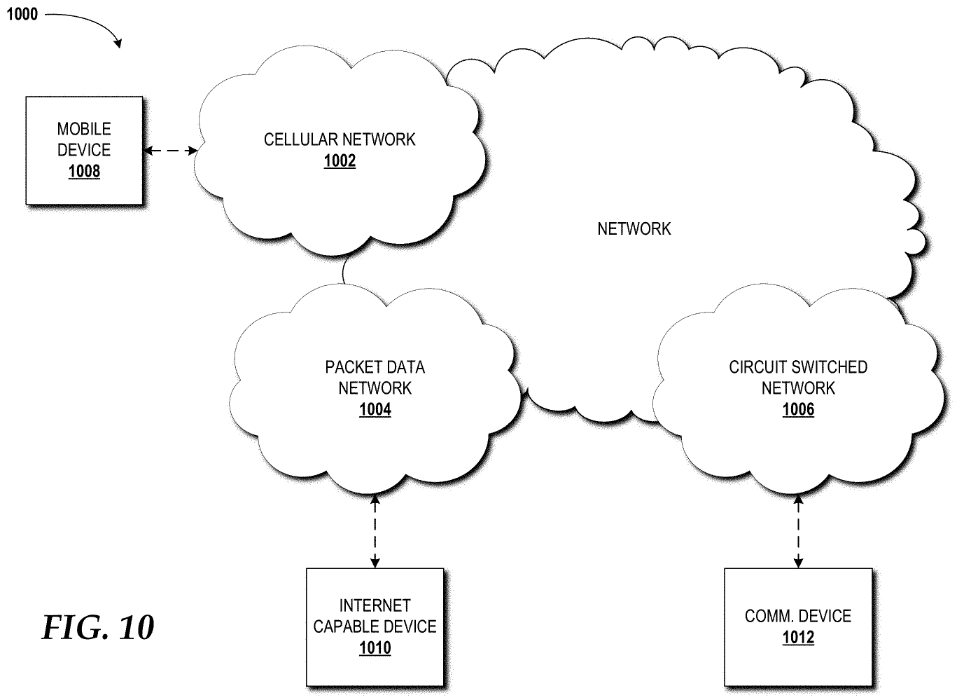

From operation 602, the method 600 proceeds to operation 604. At operation 604, the SGRM module 412 analyzes the contribution level of each entity involved in the collaboration, and creates relationship linkage to each of the license options 110 agreed to by the asset creator 102 and the collaborator(s) 104. An example of this is shown in the relationship graph 200 of FIG. 2. It should be noted that if a disagreement occurs, the collaboration can be stopped since unresolved agreements should not proceed to the next stage (i.e., compensation), described below with reference to FIG. 10. Each link in the relationship graph 200 can include, minimally, the following metadata attributes: asset creator ID, collaborator ID, license option of the asset creator ID, and collaboration share (i.e., whether the entire asset 106 or a portion of the asset 106 is in the scope of the collaboration).

From operation 604, the method 600 proceeds to operation 606. The method 600 can end at operation 606.

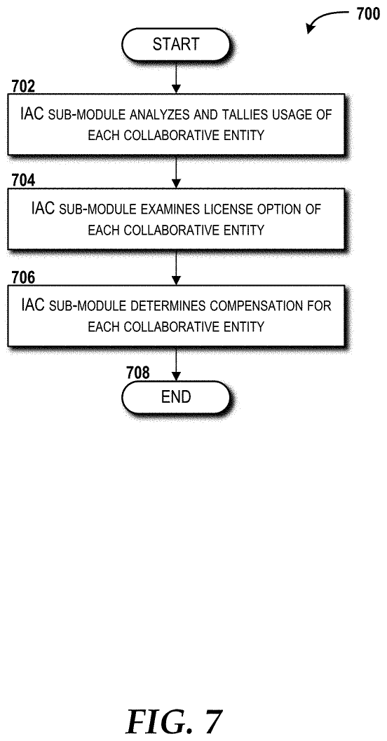

Turning now to FIG. 7, a flow diagram illustrating aspects of a method 700 for calculating contributions of the entities involved in a collaboration to ensure fair compensation among the entities will be described, according to an illustrative embodiment of the concepts and technologies disclosed herein. The method 700 will be described with reference to FIG. 7 and further reference to FIG. 4.

The method 700 begins and proceeds to operation 702. At operation 702, the IAC sub-module 416 analyzes and tallies the usage of each collaborative entity. The usage can be tallied periodically. Alternatively, usage can be tallied in response to a request by any entity. From operation 702, the method 700 proceeds to operation 704. At operation 704, the IAC sub-module 416 examines the licenses option(s) 110 of each collaborative entity. From operation 704, the method 700 can proceed to operation 706. At operation 706, the IAC sub-module 416 determines compensation for each collaborative entity. From operation 706, the method 700 proceeds to operation 708. The method 700 can end at operation 708.

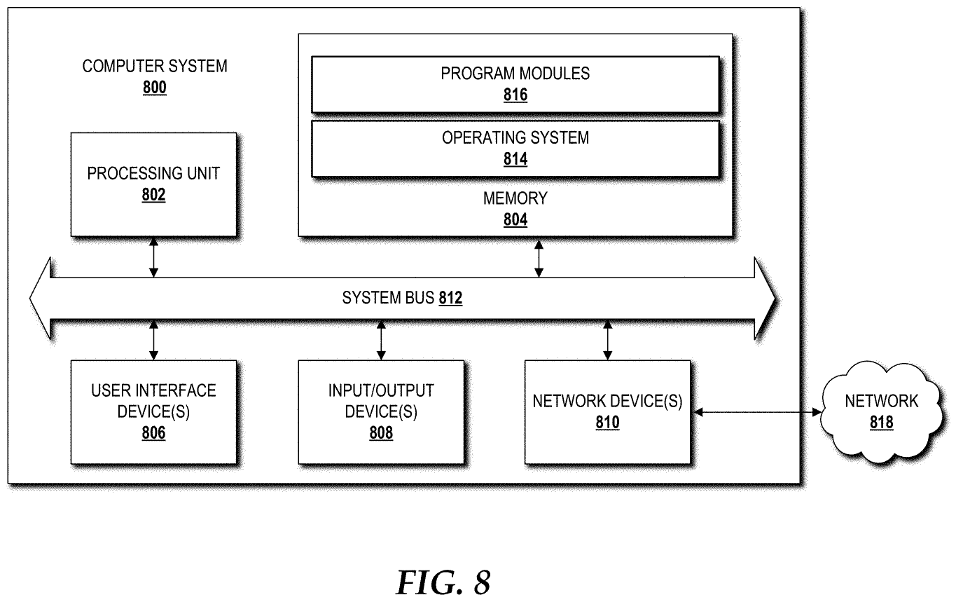

Turning now to FIG. 8, a block diagram illustrating a computer system 800 configured to provide the functionality described herein in accordance with various embodiments of the concepts and technologies disclosed herein will be described. One or more computer systems used to execute the UI module 402, the EMDAC module 404, the FDMLO module 406, the MCDO module 408, the SGRM module 412, and the AAOCM module 414 can be configured like and/or can have an architecture similar or identical to the computer system 800 described herein with respect to FIG. 8. It should be understood, however, that any of these systems, devices, or elements may or may not include the functionality described herein with reference to FIG. 8.

The computer system 800 includes a processing unit 802, a memory 804, one or more user interface devices 806, one or more input/output (“I/O”) devices 808, and one or more network devices 810, each of which is operatively connected to a system bus 812. The bus 812 enables bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, or other type of processor known to those skilled in the art and suitable for controlling the operation of the computer system 800.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like. The program modules 816 can include various software and/or program modules described herein, such as the UI module 402, the EMDAC module 404, the FDMLO module 406, the MCDO module 408, the SGRM module 412, and the AAOCM module 414, or any combination thereof.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium,” “computer-readable storage medium,” and variations thereof does not include waves or signals per se and/or communication media.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer to output data.

The network devices 810 enable the computer system 800 to communicate with one or more networks 818. Examples of the network devices 810 include, but are not limited to, a modem, a RF or infrared (“IR”) transceiver, a telephonic interface, a bridge, a router, or a network card. The network(s) may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network(s) may be a wired network such as, but not limited to, a WAN such as the Internet, a LAN, a wired PAN, or a wired MAN.

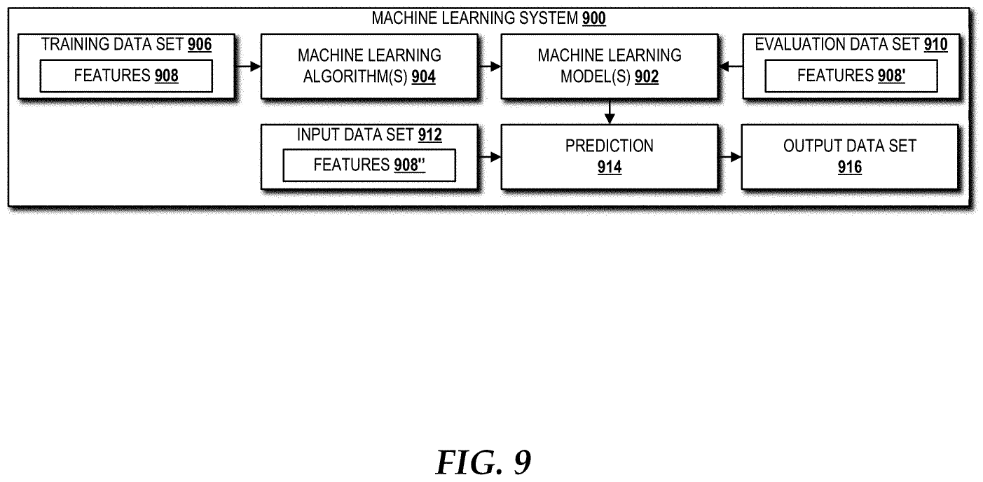

Turning now to FIG. 9, a machine learning system 900 capable of implementing aspects of the embodiments disclosed herein will be described. The illustrated machine learning system 900 includes one or more machine learning models 902. The asset 106 created by the asset creator 102 and the enhanced asset 112 created by the collaborator(s) 104 based upon the asset 106 can be or can include the machine learning model(s) 902. The machine learning models 902 can include supervised and/or semi-supervised learning models. The machine learning model(s) 902 can be created by the machine learning system 900 based upon one or more machine learning algorithms 904. The asset 106 created by the asset creator 102 and the enhanced asset 112 created by the collaborator(s) 104 based upon the asset 106 can be or can include the machine learning algorithm(s) 904. The machine learning algorithm(s) 904 can be any existing, well-known algorithm, any proprietary algorithms, or any future machine learning algorithm. Some example machine learning algorithms 904 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 904 based upon the problem(s) to be solved by machine learning via the machine learning system 900.

The machine learning system 900 can control the creation of the machine learning models 902 via one or more training parameters. In some embodiments, the training parameters are selected modelers at the direction of an enterprise, for example. Alternatively, in some embodiments, the training parameters are automatically selected based upon data provided in one or more training data sets 906. The training parameters can include, for example, a learning rate, a model size, a number of training passes, data shuffling, regularization, and/or other training parameters known to those skilled in the art. The training data in the training data sets 906, in some embodiments, can be provided by the collaborator(s) 104.

The learning rate is a training parameter defined by a constant value. The learning rate affects the speed at which the machine learning algorithm 904 converges to the optimal weights. The machine learning algorithm 904 can update the weights for every data example included in the training data set 906. The size of an update is controlled by the learning rate. A learning rate that is too high might prevent the machine learning algorithm 904 from converging to the optimal weights. A learning rate that is too low might result in the machine learning algorithm 904 requiring multiple training passes to converge to the optimal weights.

The model size is regulated by the number of input features (“features”) 908 in the training data set 906. A greater the number of features 908 yields a greater number of possible patterns that can be determined from the training data set 906. The model size should be selected to balance the resources (e.g., compute, memory, storage, etc.) needed for training and the predictive power of the resultant machine learning model 902.

The number of training passes indicates the number of training passes that the machine learning algorithm 904 makes over the training data set 906 during the training process. The number of training passes can be adjusted based, for example, on the size of the training data set 906, with larger training data sets being exposed to fewer training passes in consideration of time and/or resource utilization. The effectiveness of the resultant machine learning model 902 can be increased by multiple training passes.

Data shuffling is a training parameter designed to prevent the machine learning algorithm 904 from reaching false optimal weights due to the order in which data contained in the training data set 906 is processed. For example, data provided in rows and columns might be analyzed first row, second row, third row, etc., and thus an optimal weight might be obtained well before a full range of data has been considered. By data shuffling, the data contained in the training data set 906 can be analyzed more thoroughly and mitigate bias in the resultant machine learning model 902.

Regularization is a training parameter that helps to prevent the machine learning model 902 from memorizing training data from the training data set 906. In other words, the machine learning model 902 fits the training data set 906, but the predictive performance of the machine learning model 902 is not acceptable. Regularization helps the machine learning system 900 avoid this overfitting/memorization problem by adjusting extreme weight values of the features 908. For example, a feature that has a small weight value relative to the weight values of the other features in the training data set 906 can be adjusted to zero.

The machine learning system 900 can determine model accuracy after training by using one or more evaluation data sets 910 containing the same features 908′ as the features 908 in the training data set 906. This also prevents the machine learning model 902 from simply memorizing the data contained in the training data set 906. The number of evaluation passes made by the machine learning system 900 can be regulated by a target model accuracy that, when reached, ends the evaluation process and the machine learning model 902 is considered ready for deployment.

After deployment, the machine learning model 902 can perform a prediction operation (“prediction”) 914 with an input data set 912 having the same features 908″ as the features 908 in the training data set 906 and the features 908′ of the evaluation data set 910. The results of the prediction 914 are included in an output data set 916 consisting of predicted data. The machine learning model 902 can perform other operations, such as regression, classification, and others. As such, the example illustrated in FIG. 9 should not be construed as being limiting in any way.

Turning now to FIG. 10, additional details of an embodiment of the network 1000 will be described, according to an illustrative embodiment. In the illustrated embodiment, the network 1000 includes a cellular network 1002, a packet data network 1004, for example, the Internet, and a circuit switched network 1006, for example, a publicly switched telephone network (“PSTN”). The cellular network 1002 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 1002 also includes radios and nodes for receiving and transmitting voice, data, and combinations thereof to and from radio transceivers, networks, the packet data network 1004, and the circuit switched network 1006.

A mobile communications device 1008, such as, for example, a cellular telephone, a user equipment, a mobile terminal, a PDA, a laptop computer, a handheld computer, and combinations thereof, can be operatively connected to the cellular network 1002. The cellular network 1002 can be configured to utilize any using any wireless communications technology or combination of wireless communications technologies, some examples of which include, but are not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The mobile communications device 1008 can communicate with the cellular network 1002 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged between the mobile communications device 1008 and the cellular network 1002 via cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. It should be understood that the cellular network 1002 may additionally include backbone infrastructure that operates on wired communications technologies, including, but not limited to, optical fiber, coaxial cable, twisted pair cable, and the like to transfer data between various systems operating on or in communication with the cellular network 1002.

The packet data network 1004 can include various devices, servers, computers, databases, and other devices in communication with one another. The packet data network 1004 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 1004 includes or is in communication with the Internet.

The circuit switched network 1006 includes various hardware and software for providing circuit switched communications. The circuit switched network 1006 may include, or may be, what is often referred to as a plain old telephone system (“POTS”). The functionality of a circuit switched network 1006 or other circuit-switched network are generally known and will not be described herein in detail.

The illustrated cellular network 1002 is shown in communication with the packet data network 1004 and a circuit switched network 1006, though it should be appreciated that this is not necessarily the case. One or more Internet-capable systems/devices 1010, a personal computer (“PC”), a laptop, a portable device, or another suitable device, can communicate with one or more cellular networks 1002, and devices connected thereto, through the packet data network 1004. It also should be appreciated that the Internet-capable device 1010 can communicate with the packet data network 1004 through the circuit switched network 1006, the cellular network 1002, and/or via other networks (not illustrated).

As illustrated, a communications device 1012, for example, a telephone, facsimile machine, modem, computer, or the like, can be in communication with the circuit switched network 1006, and therethrough to the packet data network 1004 and/or the cellular network 1002. It should be appreciated that the communications device 1012 can be an Internet-capable device, and can be substantially similar to the Internet-capable device 1010. It should be appreciated that substantially all of the functionality described with reference to the network 1000 can be performed by the cellular network 1002, the packet data network 1004, and/or the circuit switched network 1006, alone or in combination with additional and/or alternative networks, network elements, and the like.

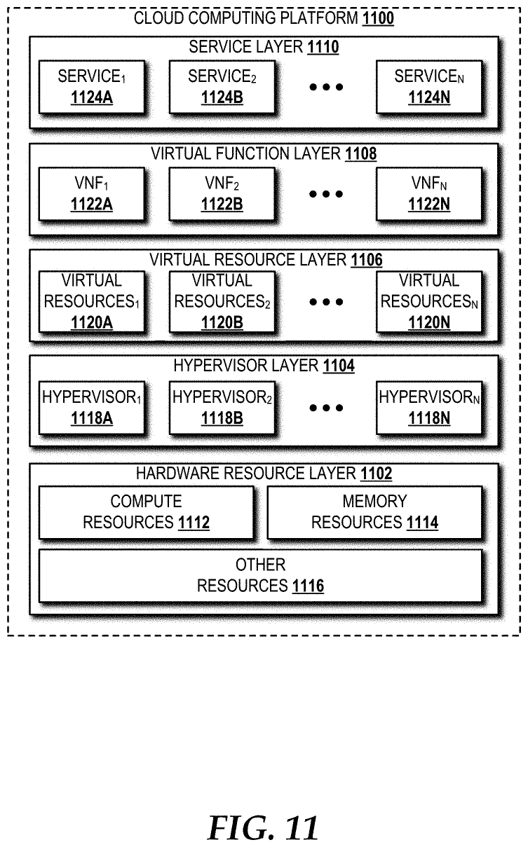

Turning now to FIG. 11, an illustrative cloud computing platform 1100 capable of implementing aspects of the concepts and technologies disclosed herein will be described, according to an illustrative embodiment. In some embodiments, the UI module 402, the EMDAC module 404, the FDMLO module 406, the MCDO module 408, the SGRM module 412, the AAOCM module 414, or some combination thereof can be implemented, at least in part, via the cloud computing platform 1100.

The cloud computing platform 1100 includes a hardware resource layer 1102, a hypervisor layer 1104, a virtual resource layer 1106, a virtual function layer 1108, and a service layer 1110. While no connections are shown between the layers illustrated in FIG. 11, it should be understood that some, none, or all of the components illustrated in FIG. 11 can be configured to interact with one other to carry out various functions described herein. In some embodiments, the components are arranged so as to communicate via one or more networks. Thus, it should be understood that FIG. 11 and the remaining description are intended to provide a general understanding of a suitable environment in which various aspects of the embodiments described herein can be implemented and should not be construed as being limiting in any way.

The hardware resource layer 1102 provides hardware resources. In the illustrated embodiment, the hardware resource layer 1102 includes one or more compute resources 1112, one or more memory resources 1114, and one or more other resources 1116. The compute resource(s) 1112 can include one or more hardware components that perform computations to process data and/or to execute computer-executable instructions of one or more application programs, one or more operating systems, and/or other software. In particular, the compute resources 1112 can include one or more central processing units (“CPUs”) configured with one or more processing cores. The compute resources 1112 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 1112 can include one or more discrete GPUs. In some other embodiments, the compute resources 1112 can include CPU and GPU components that are configured in accordance with a co-processing CPU/GPU computing model, wherein the sequential part of an application executes on the CPU and the computationally-intensive part is accelerated by the GPU processing capabilities. The compute resources 1112 can include one or more system-on-chip (“SoC”) components along with one or more other components, including, for example, one or more of the memory resources 1114, and/or one or more of the other resources 1116. In some embodiments, the compute resources 1112 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 1112 can be or can include one or more hardware components architected in accordance with an ARM architecture, available for license from ARM HOLDINGS of Cambridge, United Kingdom. Alternatively, the compute resources 1112 can be or can include one or more hardware components architected in accordance with an x86 architecture, such an architecture available from INTEL CORPORATION of Mountain View, Calif., and others. Those skilled in the art will appreciate the implementation of the compute resources 1112 can utilize various computation architectures, and as such, the compute resources 1112 should not be construed as being limited to any particular computation architecture or combination of computation architectures, including those explicitly disclosed herein.

The memory resource(s) 1114 can include one or more hardware components that perform storage/memory operations, including temporary or permanent storage operations. In some embodiments, the memory resource(s) 1114 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 1112.

The other resource(s) 1116 can include any other hardware resources that can be utilized by the compute resources(s) 1112 and/or the memory resource(s) 1114 to perform operations described herein. The other resource(s) 1116 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 1102 can be virtualized by one or more hypervisors 1118A-1118N (also known as “virtual machine monitors”) operating within the hypervisor layer 1104 to create virtual resources that reside in the virtual resource layer 1106. The hypervisors 1118A-1118N can be or can include software, firmware, and/or hardware that alone or in combination with other software, firmware, and/or hardware, creates and manages virtual resources 1120A-1120N operating within the virtual resource layer 1106.

The virtual resources 1120A-1120N operating within the virtual resource layer 1106 can include abstractions of at least a portion of the compute resources 1112, the memory resources 1114, and/or the other resources 1116, or any combination thereof. In some embodiments, the abstractions can include one or more VMs, virtual volumes, virtual networks, and/or other virtualized resources upon which one or more VNFs 1122A-1122N can be executed. The VNFs 1122A-1122N in the virtual function layer 1108 are constructed out of the virtual resources 1120A-1120N in the virtual resource layer 1106. In the illustrated example, the VNFs 1122A-1122N can provide, at least in part, one or more services 1124A-1124N in the service layer 1110.

Based on the foregoing, it should be appreciated that aspects of a multi-faceted license management approach to support a multi-layered product structure has been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
creating, by a model creation design and onboarding (“MCDO”) module executed by a processor, an asset based upon input received from an asset creator;
storing, by the MCDO module, the asset in an enhanced multi-layer digital asset catalog (“EMDAC”) module;
receiving, by the MCDO module, a search request from a collaborator;
in response to the search request, parsing, by the MCDO module, the search request to identify search criteria to be used to search the EMDAC module;
searching, by the MCDO module, the EMDAC module based upon the search criteria;
receiving, by the MCDO module, search results from the EMDAC module, wherein the search results comprise the asset;
creating, by the MCDO module, an enhanced asset based upon the asset created by the asset creator combined with a contribution based upon input received from the collaborator; and
storing, by the MCDO module, the enhanced asset in the EMDAC module.

2. The method of claim 1, further comprising:
creating, by the MCDO module, a revision of the asset based upon further input received from the asset creator; and
storing, by the MCDO module, the revision of the asset in the EMDAC module.

3. The method of claim 1, wherein the asset is associated with a first license option; and wherein the enhanced asset is associated with a second license option.

4. The method of claim 1, further comprising:
receiving, by the MCDO module, a further search request from a further collaborator;
in response to the further search request, parsing, by the MCDO module, the further search request to identify further search criteria to be used to search the EMDAC module;
searching, by the MCDO module, the EMDAC module based upon the further search criteria; and
receiving, by the MCDO module, further search results from the EMDAC module, wherein the further search results comprise the enhanced asset.

5. The method of claim 1, wherein the search results further comprise a suggested version of the asset; and wherein the EMDAC module stores a plurality of versions of the asset.

6. The method of claim 5, wherein a first version of the asset is associated with a first license option; and wherein a second version of the asset is associated with a second license option.

7. The method of claim 1, further comprising:
tracking and logging a collaboration between the asset creator and the collaborator;
analyzing a contribution level of the asset creator and the collaborator; and
creating a relationship link to at least one license option agreed to by the asset creator and the collaborator.

8. A system comprising:
a processor; and
a memory comprising instructions for a plurality of modules that, when executed by the processor, cause the processor to perform operations comprising
creating an asset based upon input received from an asset creator, storing the asset in an enhanced multi-layer digital asset catalog (“EMDAC”) module,
receiving a search request from a collaborator,
in response to the search request, parsing the search request to identify search criteria to be used to search the EMDAC module,
searching the EMDAC module based upon the search criteria,
receiving search results from the EMDAC module, wherein the search results comprise the asset,
creating an enhanced asset based upon the asset created by the asset creator combined with a contribution based upon input received from the collaborator, and
storing the enhanced asset in the EMDAC module.

9. The system of claim 8, wherein the operations further comprise:
creating a revision of the asset based upon further input received from the asset creator; and
storing the revision of the asset in the EMDAC module.

10. The system of claim 8, wherein the asset is associated with a first license option; and wherein the enhanced asset is associated with a second license option.

11. The system of claim 8, wherein the operations further comprise:
receiving a further search request from a further collaborator;
in response to the further search request, parsing the further search request to identify further search criteria to be used to search the EMDAC module;
searching the EMDAC module based upon the further search criteria; and
receiving further search results from the EMDAC module, wherein the further search results comprise the enhanced asset.

12. The system of claim 8, wherein the search results further comprise a suggested version of the asset; and wherein the EMDAC module stores a plurality of versions of the asset.

13. The system of claim 12, wherein a first version of the asset is associated with a first license option; and wherein a second version of the asset is associated with a second license option.

14. The system of claim 8, wherein the operations further comprise:
tracking and logging a collaboration between the asset creator and the collaborator;
analyzing a contribution level of the asset creator and the collaborator; and
creating a relationship link to at least one license option agreed to by the asset creator and the collaborator.

15. A computer-readable storage medium comprising computer-executable instructions that, when executed by a processor, cause the processor to perform operations comprising:
creating an asset based upon input received from an asset creator;
storing the asset in an enhanced multi-layer digital asset catalog (“EMDAC”) module;
receiving a search request from a collaborator;
in response to the search request, parsing the search request to identify search criteria to be used to search the EMDAC module;
searching the EMDAC module based upon the search criteria;
receiving search results from the EMDAC module, wherein the search results comprise the asset;
creating an enhanced asset based upon the asset created by the asset creator combined with a contribution based upon input received from the collaborator; and
storing the enhanced asset in the EMDAC module.

16. The computer-readable storage medium of claim 15, wherein the operations further comprise:
creating a revision of the asset based upon further input received from the asset creator; and
storing the revision of the asset in the EMDAC module.

17. The computer-readable storage medium of claim 15, wherein the asset is associated with a first license option; and wherein the enhanced asset is associated with a second license option.

18. The computer-readable storage medium of claim 15, wherein the operations further comprise:
receiving a further search request from a further collaborator;
in response to the further search request, parsing the further search request to identify further search criteria to be used to search the EMDAC module;
searching the EMDAC module based upon the further search criteria; and
receiving further search results from the EMDAC module, wherein the further search results comprise the enhanced asset.

19. The computer-readable storage medium of claim 15, wherein the search results further comprise a suggested version of the asset; wherein the EMDAC module stores a plurality of versions of the asset; and wherein a first version of the asset is associated with a first license option; and wherein a second version of the asset is associated with a second license option.

20. The computer-readable storage medium of claim 15, wherein the operations further comprise:
tracking and logging a collaboration between the asset creator and the collaborator;
analyzing a contribution level of the asset creator and the collaborator; and
creating a relationship link to at least one license option agreed to by the asset creator and the collaborator.
